(19) United States
(12) Patent Application Publication
(10) Pub. No.: US 2011/0013389 A1
(43) Pub. Date: Jan. 20, 2011

(54) LIGHTING SYSTEM

(75) Inventors: Oscar Hendrikus Willemsen, Eindhoven (NL); Willem Lubertus Ijzerman, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/934,679

(22) PCT Filed: Mar. 24, 2009
(86) PCT No.: PCT/IB09/51214

§ 371 Date: Sep. 27, 2010

(30) Foreign Application Priority Data
Apr. 1, 2008 (EP) 08153895.1

(51) Int. Cl. F21V 9/00; F21S 4/00; F21V 11/00; F21V 7/00

(52) U.S. Cl. 362/231; 362/249.01; 362/235; 362/249.02

(57) ABSTRACT

This invention relates to a lighting system (100) which provides front side lighting, where a main portion of the light is outputted in the front direction of the lighting system, and back side lighting, where a sub portion of the light is outputted in a back side direction of the lighting system. The lighting system is arranged such that light from a light unit (103) is mixed in a mixing chamber (105). The mixing chamber has a first light exit portion (106) which is arranged for outputting a main portion of the mixed light for front side lighting. The mixing chamber is further arranged with a second light exit portion (101) arranged in association with the mixing chamber for outputting a sub portion of the mixed light for back side lighting from the lighting system. The invention is based on an insight that by utilizing the mixing chamber in the lighting system, back side lighting is achieved and thereby hardly affecting the beam shape of the front side lighting from the lighting system.

### FIELD OF THE INVENTION

The present invention relates generally to lighting systems and more particularly to a lighting system with backside lighting and a corresponding method for providing back side lighting.

### BACKGROUND OF THE INVENTION

Lighting systems used for lighting of buildings have previously typically been provided with fluorescent light sources. It is however expected that light emitting diode (LED) based lighting systems will increasingly replace fluorescent light source based lighting systems within the next coming years. Due to their characteristics, such as low power consumption, color generating capabilities, low working temperature, small size etc., LEDs are suitable to use in thin, flat surfaced lighting systems, which are much flatter and more compact than conventional lighting systems, such as an example the Philips MASTER Line 111 Halogen lamp. Thus, LED-based lighting systems provide good conditions to integrate the lighting in the interior of a room or building in an unobtrusive manner. Instead of utilizing built-in lighting panels in a ceiling, which is a typical prior art solution for providing unobtrusive lighting, flat lighting systems can be suspended from the ceiling in a room without taking up a lot of space or feeling bulky. However, when providing pendent lights shadowing effects may cause an unattractive atmosphere in the room. Also, in office environments, it is often desired to provide direct lighting, or front side lighting, for workspaces and at the same time indirect lighting, or back side lighting, for providing a general atmosphere.

Lighting systems called Orea and Aero, which are produced by Zumbtobel, provide back side lighting based on a technique in which the lighting systems have a transparent light guiding body in which fluorescent lamps are arranged. Light is guided towards the ceiling by the transparent light guiding body and is furthermore controlled by foldable reflectors that are mounted onto the light guiding body for adjusting the back side lighting of the lighting system. The lighting systems are based on traditional lighting technology and are as described above therefore thick in comparison to LED-based luminaries. Furthermore, the foldable reflectors are protruding from the lighting systems and are mechanically adjusted to achieve a desired light distribution for the back side lighting.

### SUMMARY OF THE INVENTION

It is an object of the present invention to provide back side lighting in a LED-based lighting system that alleviates at least one of the above-mentioned drawbacks of the prior art.

This object is achieved by a lighting system and a method according to the present invention as defined in the appended independent claims. Preferred embodiments are set forth in the dependent claims and in the following description and drawings.

Thus, in accordance with a first aspect of the present invention, there is provided a lighting system having a front side and a back side. The lighting system comprises: a light unit having at least one light source, a mixing chamber arranged to receive and mix light from the light unit. The mixing chamber has a first light exit portion and a second light exit portion. The first light exit portion is arranged for outputting a main portion of the mixed light via the front side for front side lighting. The second light exit portion is arranged for outputting a sub portion of the mixed light via the back side for back side lighting.

Hence, there is provided a lighting system having front side lighting and an integrated back side lighting which are arranged in connection to a mixing chamber. By utilizing a mixing chamber to mix the light from the light sources, the visibility of the individual position of a light source is decreased in the far field. Integration of the second light exit portion in the light mixing chamber hence allows for extraction of a part, or sub parts, of the mixed light for back side lighting, which is independent of the positioning and individual light distribution of each light source. Furthermore, extraction of back side lighting in accordance with the present invention also has the benefit that the effect on the beam shape of the outputted main portion of the mixed light, i.e. on the beam shape of the light front side lighting from the lighting system due to the light extraction for back side lighting is insignificant. The resulting light from the lighting system according to the present invention thus provides required main light, for instance work light in a room, and at the same time back side lighting for eliminating shadowing effects which often occur when arranging pendent lighting systems.

The front side is the side from which the main portion of the light from the lighting system is outputted. This is referred to as the front side lighting. The back side is as the side from which back side lighting of the lighting system occurs. The front side and the back side may be positioned on opposite sides of the lighting system. This is appropriate when the lighting system is arranged in a ceiling and the front side lighting has the purpose of illuminating a room or a working station etc., and the back side lighting has the purpose of reducing shadowing effects that occur or has the purpose of providing atmospheric light directed to the back, e.g. the ceiling, when a lighting system is pendent from a surface.

The main portion of light which is outputted as front side lighting is typically larger than the back side lighting, which comprises a sub portion of the light outputted from the lighting system.

It may also be that the front side and the back side are arranged on adjacent sides of the lighting system, e.g. when the lighting system is arranged on a wall and the front side lighting has the purpose of providing an up-light and the back side lighting has the purpose of providing atmospheric light lighting up the wall itself. Other combinations of the positioning of the front side and back side are also possible and are considered to fall within the scope of the present invention.

In accordance with an embodiment of the lighting system, the second light exit portion comprises at least one light transfer region for transferring a sub portion of mixed light to the back side for back side lighting.

In accordance with an embodiment of the lighting system, the at least one light transport region is arranged as a hole, which is convenient as the second light exit portion is then realized by adding an opaque layer which is arranged one or more holes. This step is preferably integrated in the manufacturing process of the mixing chamber.

In accordance with an embodiment of the lighting system, the at least one light transport regions comprises a light guide. When providing light transport regions comprising light guides the light transportation from the mixing chamber can be done with hardly any loss in a wave guide. Furthermore, by having an optical material integrated as light transport regions, this allows for a smooth surface of the back side of the mixing chamber. The back side may alternatively constitute the back side of the lighting system and this will provide a attractive look. A smooth surface is also convenient when it comes to keeping the lighting system clean.

In accordance with an embodiment of the lighting system, the at least one light transport region is shaped like a tapered funnel. The one or more tapered funnels may be provided with specular reflective walls and will collimate the light that enters the light transport regions from the mixing chamber. This reduces the amount of light that is allowed to re-enter the mixing chamber, e.g. light being backscattered from the exit of the light transport regions.

In accordance with an embodiment of the lighting system, the lighting system further comprises a first optical layer arranged to cover at least a portion of the first light exit portion. The first optical layer is adapted to transmit light diffusively, which will further smooth the front side lighting from the lighting system. Furthermore, and more importantly, by applying a diffuser, i.e. by providing an optical layer adapted to transmit light diffusively, the position of the LEDs is less visible or not visible at all in the far field of the lamp and also less visible or not visible when looking at the lighting system.

In accordance with an embodiment of the lighting system, at least one second optical layer each is arranged at the exit of at least one corresponding light transport region. This is advantageous for applying an optical effect on the back side lighting.

In accordance with an embodiment of the lighting system, the second at least one optical layer is adapted to transmit light diffusively. The diffusively scattering layer allows for a broad angular distribution of the light exiting from the light transport regions. This results in a smooth back side lighting and an advantageous way of creating a preferred atmosphere.

In accordance with an embodiment of the lighting system, the first and/or at least one second optical layers are light emitting layers adapted to emit light in response to excitation, and preferably phosphor layers, which is advantageous for efficiency reasons and to have more control over the quality of the light (e.g. CRI, CCT, color point stability).

In accordance with an embodiment of the lighting system, the at least one second optical layer is a color filter. Optical filters, and especially color filters provide an advantageous way of creating atmosphere of a particular choice. A light designer may create an atmosphere to provide a warm feeling to a room by using a color filter in a warm color.

In accordance with an embodiment of the lighting system, the at least one second optical layer is realized with a rotatable color wheel comprising different color filters or areas with phosphors of different colors. This, in addition to adding a certain color of light in the room, gives the availability for controlling the atmosphere created by the backs side lighting in time. A certain color can be used in the morning to make people more alert, and another color may be used in the evening to create a party mood.

In accordance with an embodiment of the lighting system, the lighting system further comprises a rotatable wheel comprising areas with different diaphragms arranged on top of the second light exit portion for intensity control of said back side lighting which advantageous.

In accordance with an embodiment of the lighting system, the at least one light source is a light emitting diode. The LED may be arranged to directly or indirectly illuminate the first optical layer. LEDs provide for long lived light sources that are energy-saving, and have the advantage that they can be used to create large lighting areas etc.

In accordance with an embodiment of the lighting system, the mixing chamber comprises a light-guide.

In accordance with an embodiment of the lighting system, the an upper side wall and a bottom side wall of the mixing chamber are at least partly arranged having a first a first reflective layer and a second reflective layer, respectively. The first light exit portion is arranged on a side surface of said mixing chamber. The second light exit portion is arranged in the first or second reflective layer.

In accordance with an embodiment of the lighting system, a light output unit, comprising a light guide wedge for collimating and redirecting the main portion of mixed light to a prismatic foil, is arranged in the lighting system for outputting the main portion of light in the front side lighting.

Further, in accordance with a second aspect of the present invention, there is provided a method for providing back side lighting in a lighting system having a back side and a front side comprising:

generating light;

receiving and mixing the generated light in a mixing chamber; and

outputting sub portions of the mixed light in a back side direction.

The outputting of sub portions of the mixed light is done by means of at least one light transfer region which is integrated in the mixing chamber, which has the advantageous as described above.

In accordance with an embodiment of the method, the method further comprises outputting a main portion of the mixed light in a front side direction for front side lighting.

In accordance with an embodiment of the method, the method further comprises coloring said back side light lighting.

In accordance with an embodiment of the method, the method further comprises controlling the intensity of the back side lighting.

These and other aspects, features, and advantages of the invention will be apparent from and elucidated with reference to the embodiments described hereinafter.

### BRIEF DESCRIPTION OF THE DRAWINGS

The invention will now be described in more detail and with reference to the appended drawings in which:

FIG. 1 a) is a cross sectional view, and b) is a top view of an embodiment of a lighting system according to the present invention;

FIG. 2 is a cross sectional view of an embodiment of a lighting system according to the present invention;

FIG. 3 is a cross sectional view of an embodiment of a lighting system according to the present invention;

FIG. 4 a) and b) are perspective views of turnable wheels for providing different sets of color filters and different sets of diaphragms, respectively, in embodiments of a lighting system according to the present invention;

FIG. 5 is a cross sectional view of an embodiment of a lighting system according to the present invention;

FIG. 6 a) and b) are cross sectional views of an embodiment of a lighting system according to the present invention, and c) is a top view of the same embodiment as in a) and b); and

FIG. 7 is a schematic illustration of an embodiment of a method according to the present invention.

### DESCRIPTION OF PREFERRED EMBODIMENTS

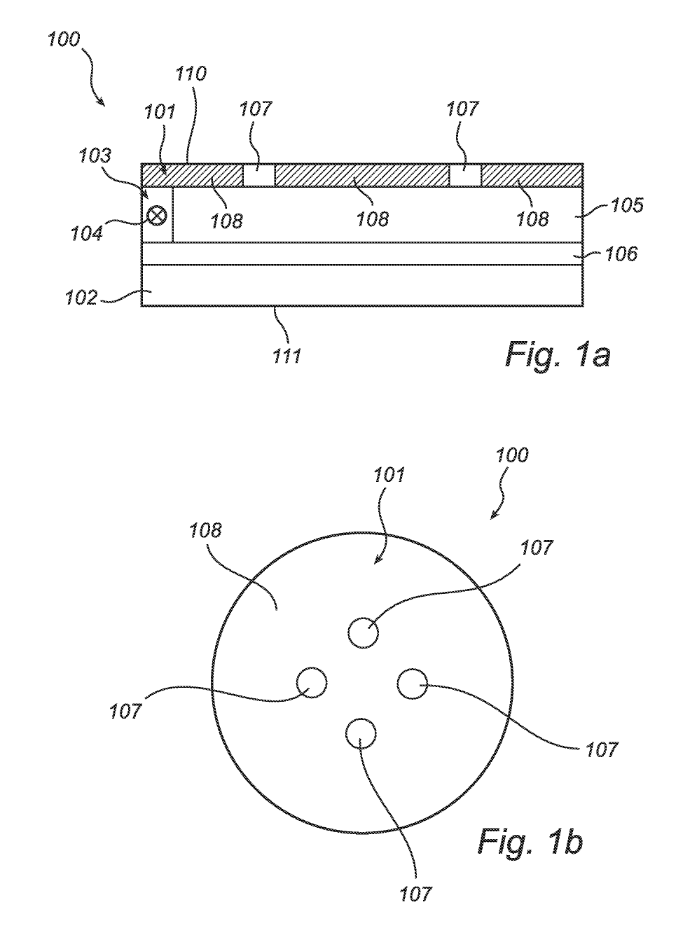

FIG. 1 illustrates the principle design of a lighting system 100 according to an embodiment of the present invention. The lighting system 100 has a front side 111 and a back side 110. The front side 111 is defined as the side from which the main portion of the light from the lighting system 100 is outputted. This is referred to as the front side lighting. The back side 110 is defined as the side from which back side lighting of the lighting system 100 occurs. The front side 111 and the back side 110 are in this embodiment positioned on opposite sides of the lighting system 100. This is appropriate when the lighting system 100 is arranged in a ceiling and the front side lighting has the purpose of illuminating a room or a working station etc., and the back side lighting has the purpose of reducing shadowing effects that occur or has the purpose of providing atmospheric light directed to the back, e.g. the ceiling, when a lighting system is pendent from a surface.

The main portion of light which is outputted as front side lighting is typically larger than the back side lighting, which comprises a sub portion of the light outputted from the lighting system. The main portion is e.g. 60%, 70%, 80%, 90%, or 99% of the total amount of outputted light.

In an alternative embodiment the front side and the back side, as defined above, are arranged on adjacent sides of the lighting system, e.g. when the lighting system is arranged on a wall and the front side lighting has the purpose of providing an up-light and the back side lighting has the purpose of providing atmospheric light lighting up the wall itself. Other combinations of the positioning of the front side and back side are also possible and are considered to fall within the scope of the present invention.

Referring again to FIG. 1, the lighting system 100 comprises a light unit 103. The light unit 103 comprises at least one light source 104, which in this embodiment is a broad spectrum light emitting diode, LED, emitting white light. White LEDs can be realized by LEDs provided with a phosphor. It is common practice to use white LEDs consisting of blue-emitting dies that excite a yellowish phosphor. The combination of yellow light and the remainder of blue light renders white light. Other types of white LEDs provided with external or internal RGB filters are also available. It should also be mentioned that a plurality of light sources 104 emitting light of different colors are suitable for the present inventive concept, as a mixing chamber 105 can be utilized to mix light originating from LEDs of different colors as well. Additionally, the at least one light source 104 can also be realized with any other suitable light source, thus other light sources are considered to fall within the scope of the present invention.

The light unit 103 is arranged in connection to a mixing chamber 105 such that the mixing chamber 105 receives light that is produced in the light unit 103. Furthermore, the mixing chamber 105 has a first light exit portion 106 which in this embodiment is arranged on a side facing towards the front side 111 of the lighting system 100. The first light exit portion 106 is arranged to output a main portion of the mixed light of the mixing chamber 105 for front side lighting. In this exemplifying embodiment the first light exit portion 106 is further engaged with a light output unit 102, and the front side lighting is here outputted via the light output unit 102, which typically may contain e.g. further optical elements, a protective sealing etc. The light output unit 102 may in alternative embodiments be left out. On a side facing towards the backside 110 of the lighting system 100 the mixing chamber 105 is arranged having a second light exit portion 101. The second light exit portion 101 comprises at least one light transport region 107 (two light transport regions are visible in the cross sectional view of an embodiment of the present invention as depicted in FIG. 1 a).

The light transport regions 107 are arranged to transfer sub portions of mixed light to the back side 110 for back side lighting. The distribution of the light transport regions 107 laterally is dependent on the lighting system and its intended use. However, an even distribution of the light transport regions 107 is preferable in most cases.

The size of the light transport regions 107 will affect the cooling capacity of the lighting system 100.

The openings forming the light transport regions 107 should not be too large as this will limit the lumen output from the at least one light source 104 via the front side 111.

In the embodiment as described above, the second light exit portion 101 comprises opaque regions 108 and spatially distributed light transport regions 107. The light transport regions 107 are here provided as light transmitting regions in an otherwise continuous opaque region 108. This can be achieved e.g. by applying a material on the top surface of the mixing chamber to form an opaque layer 108 while the top surface is masked with a protective coating protecting circular regions (or any other shape) from being covered by the material. The protective coating is subsequently removed such that holes 107 are arranged in the layer 108. The material and technique used to apply the material onto the top surface of the mixing chamber can be chosen to fit various demands on the lighting system.

In an alternative embodiment of the lighting system according to the present invention the light transport regions 107 are arranged as regions comprising a light guide material. The material in the light guide may in general and advantageously have an optical absorption less than 0.3/m, provide low haze and scattering, and only contain particles smaller than 200 nm.

In an alternative embodiment the light extraction from the mixing chamber 105 to the light transfer regions 107 can be done via light extraction areas (not shown) which are arranged at the surface between the mixing chamber and the light transfer regions. These light extraction areas can comprise for instance white paint.

In an alternative embodiment the light exit portion 101 is partially transparent and partially reflective to transfer sub portions of mixed light to the back side 110 for back side lighting

The side walls of the mixing chamber 105 are realized using a highly reflective optical material. The exit face of the chamber can include an optical diffuser, such that the individual position of the light source 104 becomes hardly visible as the light is mixed in the mixing chamber 105. Alternatively, the mixing chamber can be a light guide, that might partly be covered by reflective coatings. The exit surfaces provided via the first and second light exit portions 106 and 101, can be covered with a diffuser, which is preferably not in optical contact with the light guide.

In an alternative embodiment of the lighting system 100, the light unit 103 is integrated in the mixing chamber 105, such that an individual light source 104 is located within the mixing chamber 105, i.e. the individual LED is positioned in the mixing chamber, see light sources 104 in FIGS. 6a and 6c. Thus the light emitted from the light source 104 is distributed directly in the mixing chamber 105. This is advantageous from the view of compactness and robustness of the lighting system. It also ensures that a substantial part of light emitted from the light source 104 can be effectively employed and is not lost as stray light or heat (absorption).

Alternatively the light from the LEDs is coupled into the mixing chamber via holes that match the positions of the individual LEDs.

In the lighting systems according to the present inventive concept, a variable amount of light can be tapped from the mixing chamber 105.

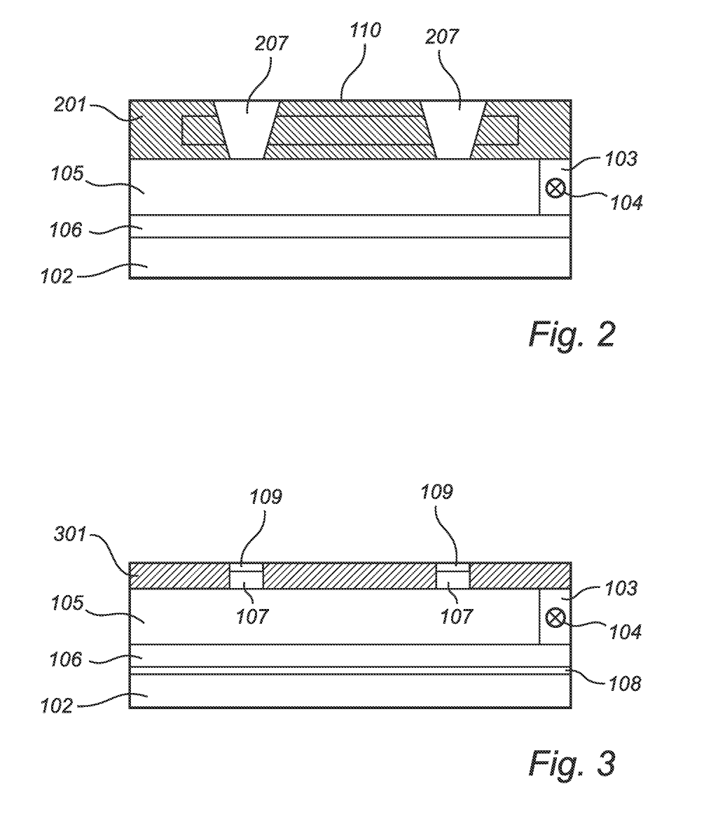

In an embodiment of a lighting system according to the present invention with a basic structure similar to the above described embodiment, and as illustrated in FIG. 2, the second light exit portion 201 comprises a plurality of light transport regions 207 arranged to transfer sub portions of mixed light to the back side 110 for back side lighting, which light transport regions 207 are shaped as tapered funnels. Light transport regions shaped like tapered funnels collimate the light from the mixing chamber 105.

An embodiment of a lighting system according to the present invention, as illustrated in FIG. 3, has the same principle structure as the embodiment described above with reference to FIG. 1. However, in this embodiment the first light exit portion 106 comprises a first optical layer 108, which comprises a phosphor layer. The first light exit portion 106, and hence the first optical layer 108 is arranged between the mixing chamber 105 and the light output unit 102. The at least one light source 104 is here a white light emitting LED or a blue LED and the first optical layer 108 will act as a remote phosphor system with the light emitted from the light source 104. The light emitted from the LED 104 is first mixed in the mixing chamber 105 before reaching the first optical layer 108 under different angles. The first optical layer 108 converts light from the light source 104 to another wavelength which is diffusively reemitted. Hence diffuse light will therefore exit from the first light exit portion 106 and be outputted from the lighting system via the light output unit 102 (or as in alternative embodiments having no explicit light output unit, via the front side for front side lighting).

Furthermore, in this embodiment the exit of the light transport regions 107 are provided with a second optical layer 109. The light that is extracted from the mixing chamber 105 and that exits the light transport regions 107 will thus additionally be affected by the second optical layer 109. The second optical layer 109 is a diffuser. Hence, diffuse light is extracted via the light transport region exits and provides a diffuse back side lighting of the lighting system.

In alternative embodiments, the second optical layer 109 is realized with a color filter of desired color, or a stack comprising both a diffuser and a color filter. Thus, diffuse and/or colored light is extracted via the light transport region exit and provides a diffuse and/or colored back side lighting of the lighting system.

In embodiments in which light is generated by phosphor converted white LEDs the optical layer at the exit of the light transport regions comprises a diffuser or alternatively a stack comprising a diffuser and a color filter.

In another embodiment of the lighting system, as illustrated in FIG. 3, the at least one light source 104 is a blue LED based on GaN (gallium nitride) and InGaN (indium gallium nitride). The first and second optical layers 108 and 109 are here provided with a yellow phosphor layer. However, phosphor layers of any desired color can be used to realize the first and second optical layer 108, 109 depending on what color of light the light source 104 emits, and depending on the desired color of the back side and front side lighting.

We can compare this embodiment with the embodiment as described above in which a white phosphor based LED is used as light source 104. Here, when having a phosphor layer 109 arranged at the exit of the light transport regions 107 in combination with the LED in the light source, this will render a remote phosphor system, i.e. a system in which the phosphor is not applied directly onto the die as in the preceding embodiment. The blue light emitted from the light source 104 is mixed in the mixing chamber 105. Some of the light from the mixing chamber 105 reaches, via the light transport regions 107, the yellow phosphor layer 109. The blue light is converted to another wavelength. The converted light is diffusive and an atmosphere back side lighting is achieved. Advantages of arranging the phosphor layer as the second optical layer 109, as compared to using LEDs with phosphors arranged at the die, are better control over the color of the produced light since not all phosphor materials can withstand high temperatures close to the die, a higher efficiency as less light is reemitted back to the die, and the diffusively reemitted light providing the atmosphere light.

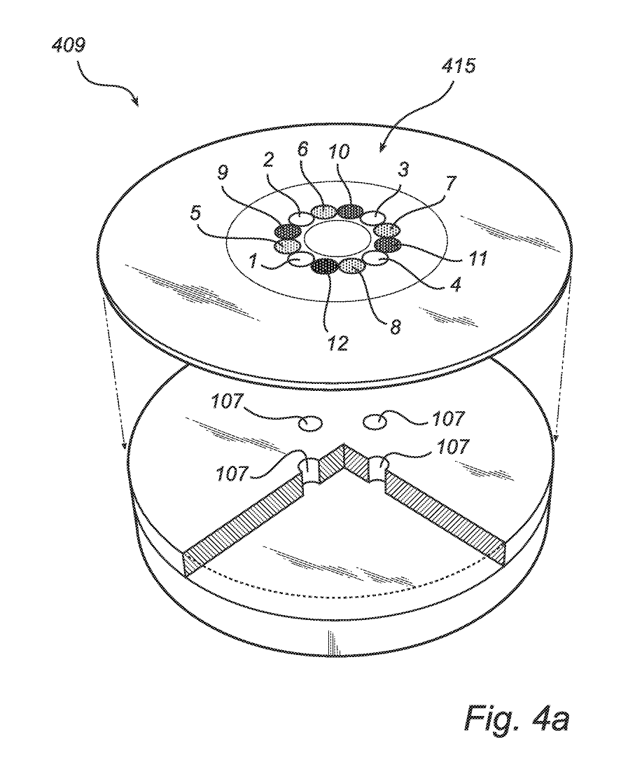

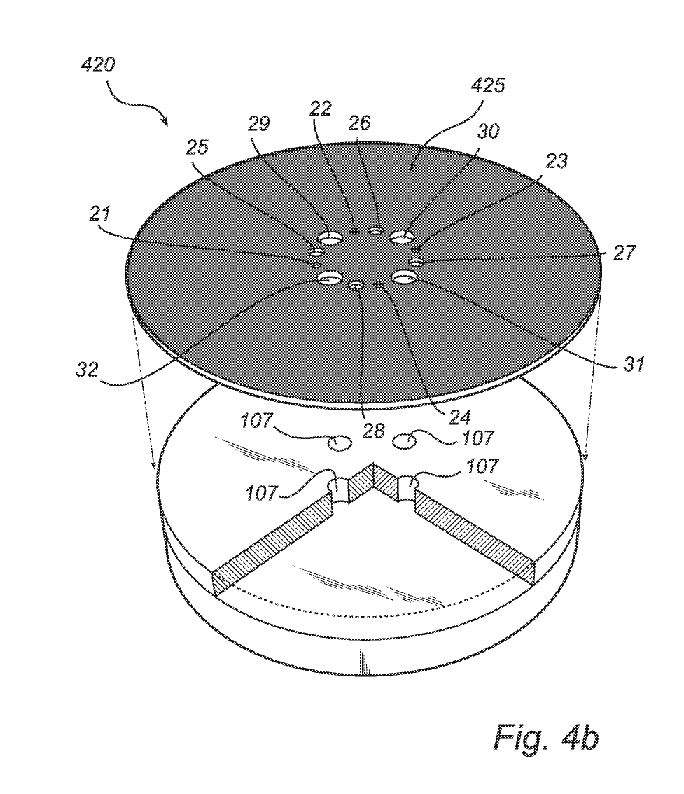

In an embodiment of the lighting system according to the present invention, the functionality of the second optical layer 109 is realized with a rotatable color wheel 409. The exemplifying rotatable color wheel 409, as illustrated in FIG. 4 a), is arranged for a lighting system having four light transport regions 107 arranged in the second light exit portion 101, as illustrated in FIG. 4 a). The rotatable color wheel 409 comprises a main body 415 in which twelve areas 1-12, each corresponding to a second optical layer 109, are arranged in a circle. These twelve areas 1-12 constitute three sets of optical layers: areas 1-4 form a first set having a first color, areas 5-8 form a second set having a second color, and areas 9-12 form a third set having a third color. Each set is adapted to be aligned with the four light transport regions 107, as the rotatable color wheel is arranged in the lighting system 100 and the first, second or third color, respectively, is selected by rotating the color wheel into a first, second or third position, respectively. To obtain the individual colors, the areas 1-12 are provided as coatings of one or more layers of different phosphors or different mixtures of phosphors of desired excitation color (which phosphors also are adapted to the color of the light sources 104). Alternatively, the individual colors are obtained by realizing areas 1-12 with color filters of the desired colors.

In an embodiment of the lighting system according to the present invention, the concept of using a rotatable wheel to modulate the back side lighting is used to control the intensity of the back side lighting. The structure of the rotatable wheel 420 for controlling the back side lighting intensity, as illustrated in FIG. 4 b), is similar to the rotatable color wheel 409. The exemplifying rotatable wheel 420 is arranged for a lighting system having four light transport regions 107 arranged in the second light exit portion 101, as illustrated in FIG. 4 b). The rotatable wheel 420 comprises a main body 425 in which twelve areas 21-32, each corresponding to a diaphragm, are arranged in a circle. These twelve areas 21-32 constitute three sets of diaphragms: areas 21-24 form a first set having a first diameter, areas 25-28 form a second set having a second diameter, and areas 29-32 form a third set having a third diameter. The first diameter is e.g. smaller than the second diameter, and the second diameter is e.g. smaller than the third diameter. Each set is adapted to be aligned with the four light transport regions 107, as the rotatable wheel 420 is arranged above the light transfer regions 107 of the lighting system 100 and the first, second or third diameter of the diaphragms, respectively, is selected by rotating the color wheel into a first, second or third position, respectively. To obtain the individual diaphragms, the areas 21-32 are provided as holes with a first, second or third diameter. Thus, the three sets of diaphragms will transmit three different intensities of the back side lighting. Alternatively, the sets for transmitting different intensities of the back side lighting are realized by areas having the same diameter but different light transmission coefficients.

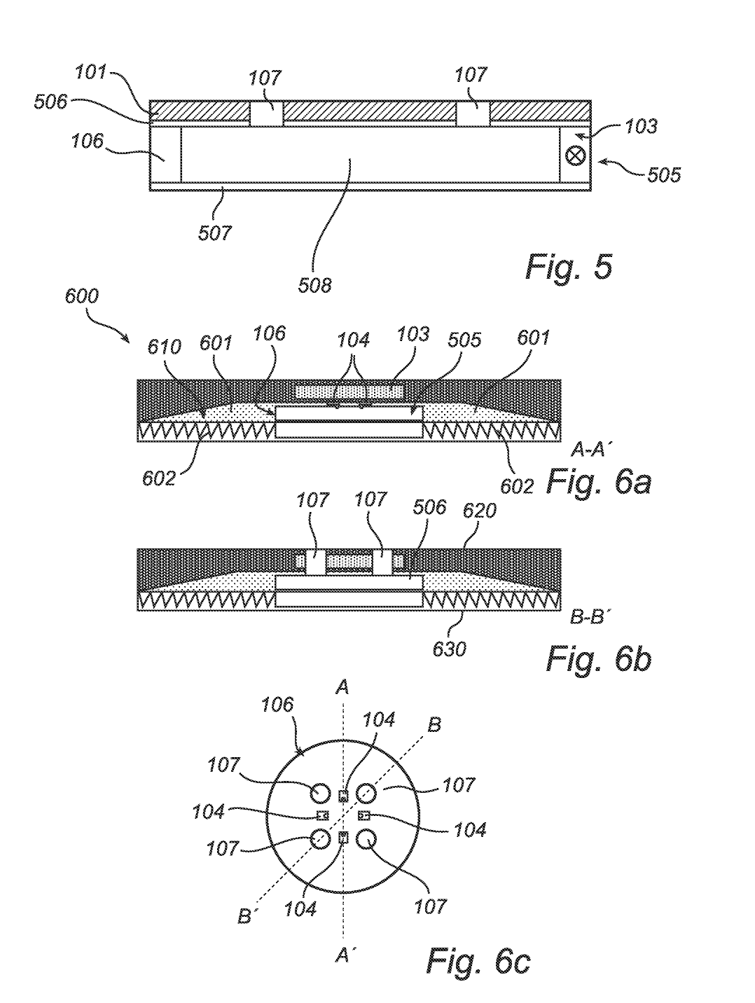

The mixing chamber of an embodiment of a lighting system according to the present invention is illustrated in FIG. 5. In this embodiment, the mixing chamber 505 comprises a light-guide 508 which upper and lower side walls are optionally provided with specularly and/or diffusely reflecting coatings such that the light-guide is arranged between a first reflective layer 507 and a second reflective layer 506. The first and second reflective layer coatings, 507 and 506, contribute to the mixing of the light originating from the tight unit 103. In this embodiment the first light exit portion 106 is arranged on a side surface of the mixing chamber 505, and more particularly on a side surface of the light-guide 508. The second light exit portion 101 is arranged at the second reflective layer 506 (or alternatively the first reflective layer 507) such that the second reflective layer 506 is arranged with light transport regions 107, which are arranged as openings distributed in the second reflective layer 506.

In an embodiment of the present invention the mixing chamber 505 is an air chamber formed within the reflective upper and lower side walls 506, 507. It is also possible to realize the mixing chamber in alternative ways. One example is by utilizing a substantially non-leaking light guide, in which case the reflective layers 506, 507 are not necessary.

An embodiment of a lighting system according to the present invention, as illustrated in FIG. 6, comprises of a light unit 103 arranged on top of a light mixing chamber 505, of the type that was described above. The lighting system 600 is illustrated in two views: A-A′ and B-B′, which are cross sections as defined in FIG. 6 c).

The lighting system has a front side 630 and a back side 620. The mixing chamber 505, as depicted in FIG. 5, comprises a cylindrical light-guide 508, which top and bottom surfaces are arranged with the first and second reflective layers 507, 506. The first light exit portion 106 is arranged at the side surface of the light guide 508, i.e. it comprises the envelope surface of the light guide 508. The first light exit portion 106 provides light to a light output unit 610 which comprises a light guide wedge 601 for collimating and redirecting light received from the first light exit portion 106, i.e. the main portion of the light from the mixing chamber, which is to be outputted as front side lighting, to a prismatic foil 602 which outputs the front side lighting in the lighting system front side 630 direction.

In an alternative embodiment the main portion of the light from the mixing chamber can be outputted in a radial direction, i.e. no redirecting of the light received from the first light exit portion is provided in the light output unit 610.

The lighting system 600 further comprises a light unit 103 having four LEDs 104 arranged through the top surface and second reflective layer 506 of the light mixing chamber 505, which was described above. Thus, the LEDs 104 emit light directly into the mixing chamber 505. Referring now to FIG. 6 c) the four light sources 104 are symmetrically arranged around the centre of the cylinder shaped lighting system 600. The light transport regions 107 are arranged ranging from the second reflective layer 506 of the mixing chamber 505 through the light unit 103 and up to the back side of the lighting system 620. In this embodiment the light transport regions 107 are arranged symmetrically distributed and around the centre of the cylinder shaped lighting system 600, yet being displaced a distance to provide room for the LEDs 104 of the light unit 103.

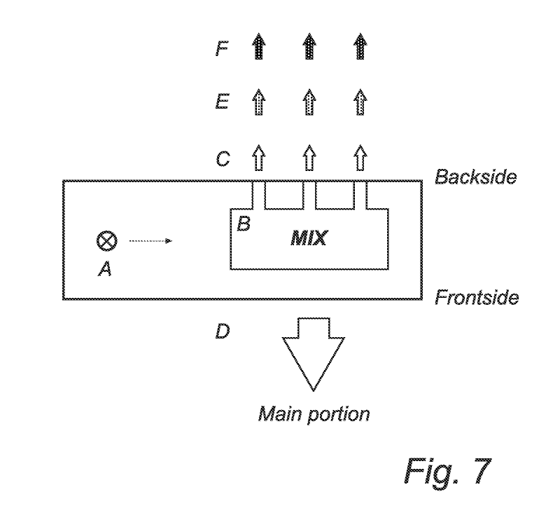

A method for providing back side lighting in a lighting system having a front side and a back side is herein after described with reference to FIG. 7. The method comprises generating light with a light source (A). The generated light is received and mixed in mixing chamber (B). The mixed light is then outputted via light transfer regions that arranged in the mixing chamber so as to guide subparts of the light that is mixed in the mixing chamber out towards the back side of the lighting system (C). The main portion of the light that is mixed in the mixing chamber is however outputted towards the front side of the lighting system (D).

In an embodiment of the method according to the present invention, the sub portions of the light from the mixing chamber that are outputted via the light transfer regions in step (C) are further processed to produce back side lighting of a desired color (E). This may be done by color filtering or by providing phosphor layers as described earlier.

In an embodiment of the method according to the present invention, the step (C) or (E) is followed by a step (F) in which the intensity of the back side lighting is controlled. This may for instance be done by utilizing the previously described rotatable wheel 420.

Above, embodiments of the lighting system and method according to the present invention as defined in the appended claims have been described. These should be seen as merely non-limiting examples. As understood by a skilled person, many modifications and alternative embodiments are possible within the scope of the invention.

It is to be noted, that for the purposes of this application, and in particular with regard to the appended claims, the word “comprising” does not exclude other elements or steps, that the word “a” or “an”, does not exclude a plurality, which per se will be apparent to a person skilled in the art.

1. A lighting system having a front side and a back side, said lighting system comprising:
a light unit comprising at least one light source;
a mixing chamber arranged to receive and mix light from said light unit; said mixing chamber having a first light exit portion and a second light exit portion comprising at least one light transport region, wherein
said first light exit portion is arranged for outputting a main portion of said mixed light via the front side for front side lighting, and
said second light exit portion is arranged for outputting a sub portion of said mixed light via the back side for back side lighting.

2-3. (canceled)

4. A lighting system according to claim 1, wherein said at least one light transport region comprises a light guide.

5. A lighting system according to claim 1, wherein said at least one light transport region is shaped like a tapered funnel.

6. A lighting system according to claim 1, further comprising a first optical layer arranged to cover at least a portion of said first light exit portion, said first optical layer being adapted to transmit light diffusively.

7. A lighting system according to claim 1, wherein at least one second optical layer is arranged at the exit of at least one corresponding light transport region.

8. A lighting system according to claim 7, wherein said at least one second optical layer is adapted to transmit light diffusively.

9. A lighting system according to claim 6, wherein said first and/or second optical layers are light emitting layers adapted to emit light in response to excitation.

10. A lighting system according to claim 7, wherein said at least one second optical layer is a color filter.

11. A lighting system according to claim 7, wherein said at least one second optical layer comprises a rotatable color wheel comprising different color filters or areas with phosphors of different colors.

12. A lighting system according to claim 1, further comprising a rotatable wheel comprising areas with different diaphragms arranged on top of the second light exit portion for intensity control of said back side lighting.

13. A lighting system according to claim 1, wherein the at least one light source is a light emitting diode.

14. A lighting system according to claim 1, wherein an upper side wall and a bottom side wall of said mixing chamber are at least partly arranged having a first reflective layer and a second reflective layer, respectively, wherein said first light exit portion is arranged on a side surface of said mixing chamber, and wherein said second light exit portion is arranged in said first or second reflective layer.

15. A method for providing back side lighting in a lighting system having a back side and a front side comprising:
generating light;
receiving and mixing the generated light in a mixing chamber; and
outputting sub portions of the mixed light in a back side direction;
wherein the outputting of sub portions of said mixed light is done by means of at least one light transfer region integrated in the mixing chamber.
